(19) United States
(12) Patent Application Publication
(10) Pub. No.: US 2024/0054404 A1
(43) Pub. Date: Feb. 15, 2024

(54) INFORMATION PROCESSING SYSTEM, INFORMATION PROCESSING APPARATUS, METHOD FOR TRAINING INFERENCE MODEL, AND NON-TRANSITORY STORAGE MEDIUM

(71) Applicant: CANON KABUSHIKI KAISHA, Tokyo (JP)

(72) Inventors: KOHTARO UMEZAWA, Tokyo (JP); RYUTA UEDA, Tokyo (JP); RITSUYA TOMITA, Kanagawa (JP)

(21) Appl. No.: 18/446,313

(22) Filed: Aug. 8, 2023

(30) Foreign Application Priority Data
Aug. 12, 2022 (JP) 2022-128578

(51) Int. Cl. G06N 20/00; G06N 5/04

(52) U.S. Cl. CPC G06N 20/00; G06N 5/04

(57) ABSTRACT

An information processing system includes first and second information processing apparatuses. The first information processing apparatus includes a first acquisition unit that acquires a first inference model based on a first neural network including an input layer, an intermediate layer group, and an output layer, a first training unit that trains the first inference model using teacher data, and a transmission unit that transmits output information based on forward propagation by the first training unit to the second information processing apparatus. The second information processing apparatus includes a second acquisition unit that acquires a second inference model based on a second neural network including an input layer, an intermediate layer group, and an output layer, wherein the second inference model is a common inference model and is similar to the first inference model, and a second training unit that trains the second inference model based on the output information.

### BACKGROUND

### Technical Field

The present disclosure relates to an information processing system and an information processing apparatus that train a neural network-based inference model, a method for training the inference model, and a non-transitory storage medium.

### Description of the Related Art

In deep learning, an inference model for use in image recognition can be pre-trained by an information processing apparatus, which is a model distribution source, of a model provider and then distributed to another information processing apparatus, which is a model distribution destination, and additionally trained with training data stored in the other information processing apparatus. Japanese Patent No. 6892844 discusses a technique for training with a watermark pattern at the information processing apparatus which is the model distribution destination.

However, the technique discussed in Japanese Patent No. 6892844 has a possibility that training unintended by the model provider may be performed. Further, if the training data for additional training is transmitted to the apparatus which is the model distribution source and the training is performed at the model distribution source, the confidentiality of the teacher data is difficult to ensure.

### SUMMARY

According to an aspect of the present disclosure, an information processing system includes a first information processing apparatus, and a second information processing apparatus communicable with the first information processing apparatus via a network. The first information processing apparatus includes a first inference model acquisition unit configured to acquire a first inference model based on a first neural network including a first input layer, a first intermediate layer group, and a first output layer, a first training unit configured to train the first inference model using teacher data, and a transmission unit configured to transmit output information based on forward propagation by the first training unit to the second information processing apparatus. The second information processing apparatus includes a second inference model acquisition unit configured to acquire a second inference model based on a second neural network including a second input layer, a second intermediate layer group, and a second output layer, wherein the second inference model is a common inference model and is similar to the first inference model, and a second training unit configured to train the second inference model based on the output information.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an information processing system according to a first exemplary embodiment.

FIG. 2 is a block diagram illustrating a hardware configuration of a first information processing apparatus according to the first exemplary embodiment.

FIG. 3 is a schematic diagram illustrating a network configuration of inference models according to the first exemplary embodiment.

FIG. 4 is a schematic diagram illustrating training processing on the inference models according to the first exemplary embodiment.

FIG. 5 is a flowchart illustrating the training processing on the inference models according to the first exemplary embodiment.

FIG. 6 is a flowchart illustrating inference processing using one of the inference models according to the first exemplary embodiment.

FIG. 7 is a schematic diagram illustrating training processing on inference models according to a first modification of the first exemplary embodiment.

FIG. 8 is a flowchart illustrating the training processing on the inference models according to the first modification of the first exemplary embodiment.

FIG. 9 is a block diagram illustrating a configuration of an information processing system according to a second exemplary embodiment.

FIG. 10 is a flowchart illustrating training processing on inference models according to the second exemplary embodiment.

FIG. 11 is a block diagram illustrating a configuration of an information processing system according to a third exemplary embodiment.

### DESCRIPTION OF THE EMBODIMENTS

Exemplary embodiments of the present disclosure can be suitably applied to medical data, such as raw data (signal data) acquired by a modality and diagnostic data generated from raw data by image reconstruction. Examples of the modality include an X-ray computed tomography (CT) device, a magnetic resonance imaging (MRI) device, a single photon emission computed tomography (SPECT) device, a positron emission tomography (PET) device, and an electrocardiograph. Inference target data and teacher data can be not only medial data but also information about a patient's privacy, such as age, gender, and disease information. The target data is not limited to medical data, and can be any data as long as the data can be used to perform inference processing in a neural network. Examples thereof include image data representing a person, text data based on document data, and audio data based on voice.

Exemplary embodiments of the present disclosure will be described below with reference to the drawings. In the drawings, similar components are denoted by the same reference numerals. Redundant description thereof will hereinafter be omitted as appropriate.

An information processing system according to an exemplary embodiment of the present disclosure demonstrates an example of a configuration for providing an inference model of high accuracy while ensuring the confidentiality of teacher data.

The information processing system includes a first information processing apparatus and a second information processing apparatus. The first information processing apparatus is an information processing apparatus of an inference model user. The second information processing apparatus is an information processing apparatus of an inference model provider and can communicate with the first information processing apparatus via a network. The first and second information processing apparatuses each include, as a common inference model, a trained inference model subjected to training processing by the model provider or an untrained inference model.

The information processing system according to an exemplary embodiment of the present disclosure performs training processing on not only a first inference model, which is the common inference model in the first information processing apparatus, but also a second inference model, which is the common inference model in the second information processing apparatus, based on the model user's teacher data while ensuring the confidentiality of the teacher data. The second information processing apparatus trains the second inference model by acquiring output information based on forward propagation of the model user's teacher data through the first inference model.

An inference model performs various tasks based on a neural network. Examples of the tasks include a task of segmenting disease areas in medical image data, a task of detecting disease areas, and a task of determining the presence or absence of diseases. The present exemplary embodiment is applicable to inference models for performing any of the tasks.

Teacher data refers to a data set for training a neural network-based inference model, and includes training data and ground truth data which is annotated training data. The training data refers to data to be used to train the inference model. In the case of performing the segmentation task, the detection task, or the presence determination task, the training data is medical image data. The ground truth data refers to data to be presented as a ground truth in training the inference model for a task. As the ground truth data, segmentation masks are stored for the segmentation task, bounding boxes indicating the coordinates of disease areas are stored for the detection task, and information about the presence or absence of diseases is stored for the presence determination task.

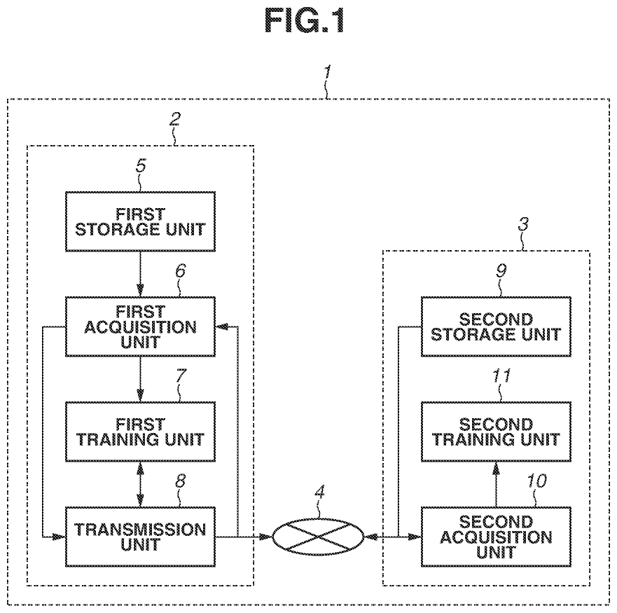

An information processing system according to a first exemplary embodiment will now be described with reference to FIG. 1.

An information processing system 1 according to the present exemplary embodiment includes a first information processing apparatus 2 and a second information processing apparatus 3. The first information processing apparatus 2 is an information processing apparatus of an inference model user, i.e., an inference model distribution destination. The second information processing apparatus 3 is an information processing apparatus of an inference model provider, i.e., an inference model distribution source and can communicate with the first information processing apparatus 2 via a network 4. The first information processing apparatus 2 includes, as a common inference model with the second information processing apparatus 3, a trained inference model subjected to training processing by the model provider in advance or an untrained inference model. In the present exemplary embodiment, an untrained inference model is provided from the inference model provider to the user.

In the present exemplary embodiment, the information processing system 1 inputs training data to a first inference model in the first information processing apparatus 2, and trains the first inference model at the first information processing apparatus 2. Loss information calculated based on output resulting from forward propagation of the training data and ground truth data is transmitted to the second information processing apparatus 3.

The second information processing apparatus 3 trains a second inference model, which is a common inference model with the first information processing apparatus 2, by backpropagation using the loss information. In the present exemplary embodiment, use of a common inference model means use of inference models that have a common network structure, are the same in terms of the presence or absence of parameters, and have common parameter values.

In the present exemplary embodiment, the information processing system 1 having such a configuration can train the second inference model in the second information processing apparatus 3 of the inference model provider without transmitting the teacher data to the second information processing apparatus 3. Moreover, the loss information and the parameters based on the loss information can be updated in a timely manner, so that the model provider can check the progress of parameter updates. This is effective as compared to a case where the model provider performs all the training processing and then acquires the updated parameters.

The loss information may be loss information calculated for a minibatch. The acquisition of loss information about a minibatch can ensure irreversibility with respect to the teacher data in the first information processing apparatus 2 based on the loss information as well as perform efficient model training.

The loss information refers to a difference between output data, which is output from an output layer of an inference model as a result of inputting medical image data to the inference model and propagating the medical image data forward through the inference model, and ground truth data in training the inference model. The inference model is trained by backpropagating the difference. In the present exemplary embodiment, the first information processing apparatus 2 is, for example, a workstation managed in a hospital, and the first inference model is trained on the workstation. The second information processing apparatus 3 is, for example, a server managed by the model creator, and the second inference model is trained on the server.

A configuration of each of the first information processing apparatus 2 and the second information processing apparatus 3 will now be described.

The first information processing apparatus 2 included in the information processing system 1, which is a model distribution destination, includes a first storage unit 5, a first acquisition unit 6, a first training unit 7, and a transmission unit 8. The first storage unit 5 stores information about the common inference model and teacher data. The first acquisition unit 6 acquires the first inference model. The first training unit 7 trains the first inference model using the teacher data. The transmission unit 8 transmits loss information to the second information processing apparatus 3.

### <First Storage Unit>

The first storage unit 5 stores training data and ground truth data as the teacher data managed by the model user, in the first information processing apparatus 2 which is the information processing apparatus of the model user. The first storage unit 5 also stores the first inference model as the common inference model distributed from the second information processing apparatus 3.

The first storage unit 5 transmits the teacher data and the first inference model to the first acquisition unit 6 based on an instruction from the first acquisition unit 6. The training data and the ground truth data included in the teacher data of the first information processing apparatus 2 may be medical image data automatically transferred from a modality or an image server in the hospital. The first storage unit 5 may be substituted by an external storage device.

### <First Acquisition Unit>

The first acquisition unit 6 acquires the teacher data and the first inference model from the first storage unit 5. The first acquisition unit 6 transmits the training data included in the teacher data and information about the first inference model to the first training unit 7.

### <First Training Unit>

The first training unit 7 inputs the training data acquired from the first acquisition unit 6 to an input layer of the first inference model acquired from the first acquisition unit 6, propagates the training data forward from the input layer to intermediate layers of the first inference model, and transmits information based on the output of the forward propagation to the transmission unit 8. In the present exemplary embodiment, the first training unit 7 acquires loss information between the output of an output layer of the first inference model and the ground truth data, and trains the first inference model by backpropagating the loss information. The first training unit 7 also transmits the loss information to the transmission unit 8 as information based on the output of the forward propagation.

### <Transmission Unit>

The transmission unit 8 transmits output information based on the output of the forward propagation to the second information processing apparatus 3. In the present exemplary embodiment, the output information is loss information which is a difference calculated between the ground truth data acquired from the first acquisition unit 6 and the output acquired from the first inference model. The loss information is transmitted to a second acquisition unit 10 included in the second information processing apparatus 3 through the network 4.

The second information processing apparatus 3 includes a second storage unit 9, the second acquisition unit 10, and a second training unit 11. The second storage unit 9 stores information about the common inference model. The second acquisition unit 10 acquires the second inference model and the output information. The second training unit 11 trains the second inference model by backpropagation based on the loss information which is the output information.

### <Second Storage Unit>

The second storage unit 9 stores the second inference model that is a common inference model and is similar to the first inference model in the first information processing apparatus 2. The second storage unit 9 may also store teacher data for pre-training before model distribution or post-training after model distribution, in the second information processing apparatus 3 which is the information processing apparatus of the model provider. The second storage unit 9 may also store inference target data for verification, which is intended to verify whether the second inference model is appropriately trained by the second training unit 11. The second storage unit 9 transmits the information about the second inference model to the first information processing apparatus 2, which is the information processing apparatus of the model user, through the network 4 as appropriate. The second storage unit 9 also transmits the information about the second inference model to the second acquisition unit 10 based on an instruction from the second acquisition unit 10.

### <Second Acquisition Unit>

The second acquisition unit 10 acquires the loss information calculated by the first training unit 7 of the first information processing apparatus 2 and the information about the second inference model, and transmits the loss information and the information about the second inference model to the second training unit 11.

### <Second Training Unit>

The second training unit 11 trains the second inference model by inputting the loss information acquired from the first information processing apparatus 2 to an output layer of the second inference model acquired from the second acquisition unit 10 and backpropagating the loss information.

The first information processing apparatus 2 and the second information processing apparatus 3 each may be configured by a computer including a processor, a memory, and a storage. In such a case, the first information processing apparatus 2 implements the functions and processing of the first storage unit 5, the first acquisition unit 6, the first training unit 7, and the transmission unit 8 by loading programs stored in the storage into the memory and causing the processor to execute the programs. The second information processing apparatus 3 implements the functions and processing of the second storage unit 9, the second acquisition unit 10, and the second training unit 11 by loading programs stored in the storage unit into the memory and causing the processor to execute the programs. However, such a configuration is not restrictive. For example, all or part of the configuration of the first information processing apparatus 2 may be implemented by a specifically designed processor such as an application specific integrated circuit (ASIC) or a field programmable gate array (FPGA). Part of the calculation processing may be performed by a processor such as a graphics processing unit (GPU) or a digital signal processor (DSP). The first information processing apparatus 2 and the second information processing apparatus 3 each may be configured by a single piece of hardware or include a plurality of pieces of hardware. For example, cloud computing or distributed computing may be used to implement the functions and processing through cooperation of a plurality of computers.

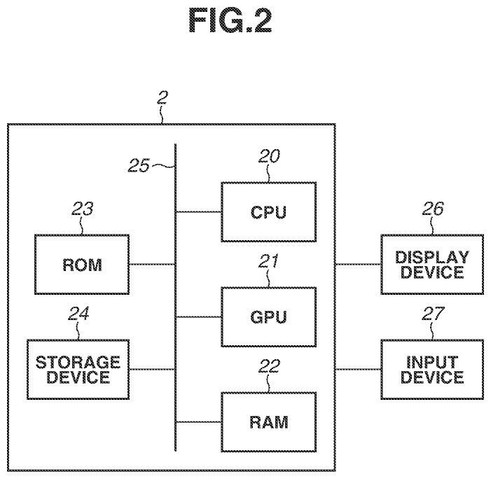

FIG. 2 illustrates an example of a specific configuration of the first information processing apparatus 2. In this example, the first information processing apparatus 2 includes a central processing unit (CPU) 20, a GPU 21, a random access memory (RAM) 22, a read-only memory (ROM) 23, and a storage device 24. These components are connected by a system bus 25. The second information processing apparatus 3 can have a similar configuration. A display device 26 and an input device 27 such as a mouse and a keyboard are also connected to the first information processing apparatus 2.

With the foregoing configuration of the first information processing apparatus 2, the user of the first inference model who manages the teacher data does not need to transmit the teacher data to an external information processing apparatus, and can train the first inference model while ensuring the confidentiality of the teacher data.

In addition, the inference model provider can improve the accuracy of the inference model by performing additional training or training of the inference model using the teacher data acquired by the inference model user. Because the model provider can check the progress of parameter updates, the foregoing configuration is also effective in terms of accuracy verification as compared to a case where the model provider performs all the training processing and then acquires the updated parameters.

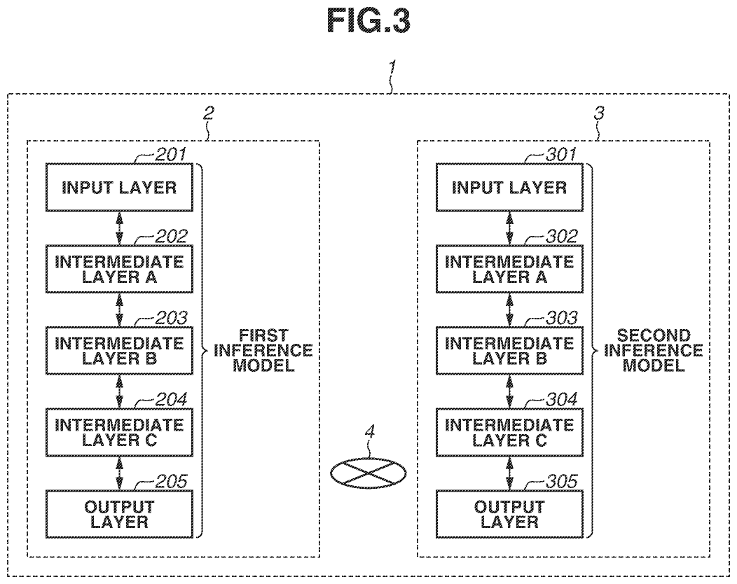

Now, a network configuration of the first and second inference models in the information processing system 1 according to the present exemplary embodiment will be described with reference to FIG. 3.

The information processing system 1 according to the present exemplary embodiment includes the first inference model and the second inference model that are disposed in the first information processing apparatus 2 and the second information processing apparatus 3, respectively.

The first and second inference models are each used as the common inference model. An input layer 201, an intermediate layer A 202, an intermediate layer B 203, an intermediate layer C 204, and an output layer 205 that form the first inference model, and an input layer 301, an intermediate layer A 302, an intermediate layer B 303, an intermediate layer C 304, and an output layer 305 that form the second inference model have a common network configuration, are the same in terms of the presence or absence of trained parameters, and have common parameters if there are trained parameters. The intermediate layer A 202, the intermediate layer B 203, and the intermediate layer C 204 form an intermediate layer group. The intermediate layer A 302, the intermediate layer B 303, and the intermediate layer C 304 form an intermediate layer group. Also in other exemplary embodiments, the first and second inference models have a common network configuration.

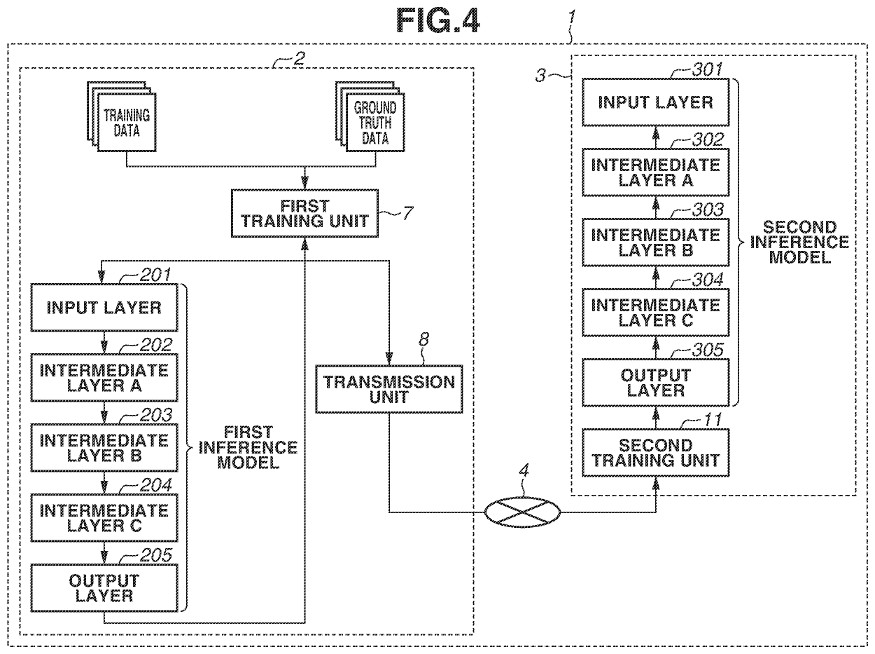

FIG. 4 schematically illustrates a training procedure for the first and second inference models according to the present exemplary embodiment.

The information processing system 1 includes the first information processing apparatus 2, which is the information processing apparatus of the inference model user, and the second information processing apparatus 3, which is the information processing apparatus of the inference model provider. As the common inference model, the first information processing apparatus 2 includes the first inference model and the second information processing apparatus 3 includes the second inference model.

The first inference model includes the input layer 201, the intermediate layer A 202, the intermediate layer B 203, the intermediate layer C 204, and the output layer 205.

The second inference model includes the input layer 301, the intermediate layer A 302, the intermediate layer B 303, the intermediate layer C 304, and the output layer 305, and is similar to the first inference model.

The first training unit 7 applies the teacher data including the training data and the ground truth data acquired from the first acquisition unit 6 to the first inference model, and performs training processing. More specifically, the first training unit 7 of the first information processing apparatus 2 inputs the training data included in the teacher data to the input layer 201 of the first inference model, and propagates the training data forward through the intermediate layer A 202, the intermediate layer B 203, and the intermediate layer C 204 up to the output layer 205. The first training unit 7 calculates, as loss information, a difference between the output information from the output layer 205 and the ground truth data, and trains the first inference model by backpropagating the loss information through the first inference model.

The first training unit 7 also transmits the loss information acquired from the first inference model to the transmission unit 8. The transmission unit 8 transmits the loss information, which is the output information based on the forward propagation by the first training unit 7, to the second information processing apparatus 3 through the network 4.

The second training unit 11 of the second information processing apparatus 3 inputs the loss information, which is the output information based on the forward propagation, acquired from the first information processing apparatus 2 to the output layer 305 of the second inference model. The second training unit 11 trains the second inference model by backpropagation, more specifically, backpropagating the loss information in order of the output layer 305, the intermediate layer C 304, the intermediate layer B 303, the intermediate layer A 302, and the input layer 301.

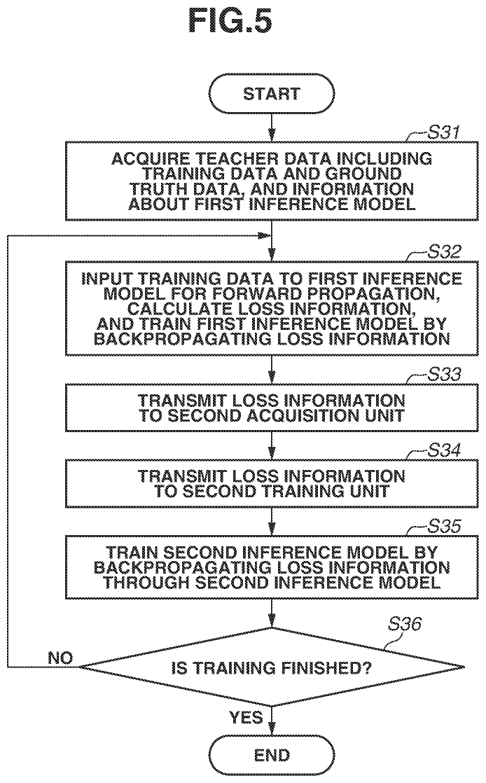

The training processing on the first and second inference models in the information processing system 1 according to the present exemplary embodiment will now be described with reference to FIG. 5.

In step S31, the first acquisition unit 6 of the first information processing apparatus 2 acquires the teacher data including the training data and the ground truth data and the information about the first inference model from the first storage unit 5, and transmits the teacher data and the information to the first training unit 7. The processing then proceeds to step S32.

In step S32, the first training unit 7 inputs the training data to the first inference model and propagates the training data forward through the first inference model. The first training unit 7 then acquires loss information between the output of the output layer 205 and the ground truth data and trains the first inference model by backpropagating the loss information. The first training unit 7 also transmits the loss information to the transmission unit 8. The processing then proceeds to step S33.

In step S33, the transmission unit 8 transmits the loss information, which is the output information based on the forward propagation by the first training unit 7, to the second acquisition unit 10 of the second information processing apparatus 3 through the network 4. The processing then proceeds to step S34.

In step S34, the second acquisition unit 10 of the second information processing apparatus 3 transmits the acquired loss information to the second training unit 11. The processing then proceeds to step S35.

In step S35, the second training unit 11 trains the second inference model by backpropagating the acquired loss information through the second inference model.

In step S36, the first training unit 7 determines whether the training of the first inference model is finished. If there is teacher data to be used for training (NO in step S36), the processing returns to step S32. If there is no teacher data (YES in step S36), the processing ends.

In the information processing system 1 according to the present exemplary embodiment, the first information processing apparatus 2 inputs the training data to the first inference model for forward propagation. The first information processing apparatus 2 then transmits the loss information calculated based on the data output from the output layer 205 and the ground truth data to the second information processing apparatus 3, so that the second inference model is trained. It is thus possible to train both the first and second inference models while ensuring the confidentiality of the medical image data. This can provide an inference model of high accuracy while ensuring the confidentiality of the training data.

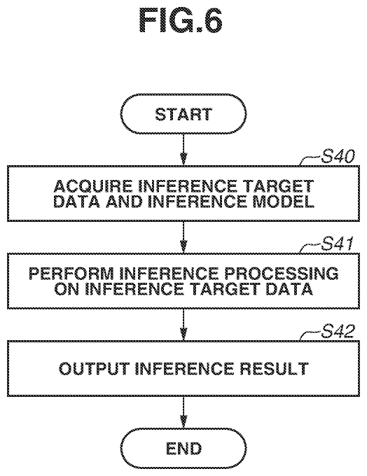

Now, inference processing using an inference model by the information processing system 1 according to the present exemplary embodiment will be described with reference to FIG. 6. In the present exemplary embodiment, the first information processing apparatus 2 and the second information processing apparatus 3 are information processing apparatuses managed by respective different entities. The first inference model in the first information processing apparatus 2 and the second inference models in the second information processing apparatus 3 are inference models that can perform inference independently of each other. Only the inference processing using the first inference model will be described here.

In step S40, an inference target data acquisition unit (not illustrated) in the first information processing apparatus 2 acquires inference target data and the first inference model from the first storage unit 5, and transmits the pieces of information to an inference unit (not illustrated). The processing then proceeds to step S41.

In step S41, the inference unit performs inference processing, to which the first information model is applied, on the inference target data, and transmits the inference result to an output unit (not illustrated). The processing then proceeds to step S42.

In step S42, the output unit outputs the inference result to the display device 26. Such a configuration enables the inference model user to acquire the inference result without transmitting the inference target data to an external information processing apparatus.

Advantages of the second information processing apparatus 3 performing the inference processing will now be described. The second information processing apparatus 3 performs the inference processing on inference target data for verification, which is intended to verify whether an inference model is appropriately trained, using the second inference model acquired through the foregoing training processing. Such a configuration enables the inference model provider to verify the performance of the inference model without transmitting the verification data to an external information processing apparatus. As will be described in detail in a third exemplary embodiment, the more high-quality teacher data is available, the more the inference model is expected to improve in performance. It is thus possible to construct an inference model of high accuracy by distributing a common inference model to inference model users that are a plurality of entities, and training the common inference model using teacher data of the plurality of inference model users.

Since the second inference model is disposed in the second information processing apparatus 3 which is the information processing apparatus of the inference model provider, the second inference model can be easily distributed as a common inference model to inference model users. This provides the effect of facilitating construction of a training environment with a plurality of users.

In the foregoing exemplary embodiment, the case has been described where, in inference model training, the first training unit 7 of the first information processing apparatus 2 calculates the loss information based on the data output from the output layer 205 and the ground truth data, the transmission unit 8 transmits the loss information as the output information based on the forward propagation to the second information processing apparatus 3, which is a server, and the second training unit 11 trains the second inference model on the server. A first modification deals with an example where output information from a predetermined intermediate layer of the first inference model is transmitted as the output information based on the forward propagation.

More specifically, the transmission unit 8 can transmit the output from the predetermined intermediate layer of the first inference model acquired by the first training unit 7 and the ground truth data to the second information processing apparatus 3. The second training unit 11 of the second information processing apparatus 3 can propagate the output information from the predetermined intermediate layer forward through the second inference model, calculate loss information between the resulting output and the ground truth data transmitted from the first information processing apparatus 2, and train the second inference model on the server by backpropagating the loss information.

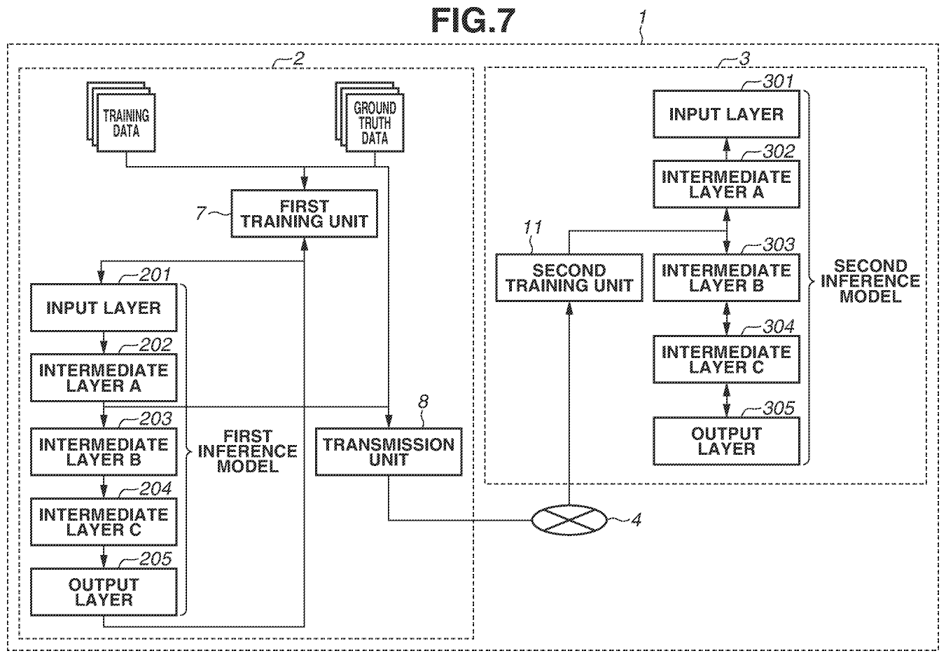

FIG. 7 schematically illustrates a procedure for training processing on the first and second inference models according to the present modification.

The information processing system 1 according to the present modification includes the first information processing apparatus 2, which is the information processing apparatus of the inference model user, and the second information processing apparatus 3, which is the information processing apparatus of the inference model provider. As the common inference model, the first information processing apparatus 2 includes the first inference model and the second information processing apparatus 3 includes the second inference model. The first inference model includes the input layer 201, the intermediate layer A 202, the intermediate layer B 203, the intermediate layer C 204, and the output layer 205. The second inference model includes the input layer 301, the intermediate layer A 302, the intermediate layer B 303, the intermediate layer C 304, and the output layer 305, and is similar to the first inference model.

The first training unit 7 performs training processing by applying teacher data, including training data and ground truth data, acquired from the first acquisition unit 6 to the first inference model. In the present modification, the first training unit 7 transmits the ground truth data to the transmission unit 8. The transmission unit 8 transmits the ground truth data to the second information processing apparatus 3.

The first training unit 7 of the first information processing apparatus 2 inputs the training data to the first inference model, and propagates the training data forward up to the intermediate layer A 202. The first training unit 7 duplicates the output information from the intermediate layer A 202 into two pieces, and transmits one to the intermediate layer B 202 and the other to the transmission unit 8. The first training unit 7 propagates the output information forward from the intermediate layer B 203 to the intermediate layer C 204 and the output layer 205. The first training unit 7 calculates, as loss information, a difference between the output information from the output layer 205 and the ground truth data, and trains the first inference model by backpropagating the loss information.

The transmission unit 8 transmits the output information from the intermediate layer A 202 to the second information processing apparatus 3.

The second training unit 11 inputs the output information from the intermediate layer A 202, which is output information based on the forward propagation by the first training unit 7, acquired from the first information processing apparatus 2 to the intermediate layer B 303 of the second inference model. The second training unit 11 propagates the output information forward in order of the intermediate layer C 304 and the output layer 305. The second training unit 11 further calculates a difference between the ground truth data acquired from the first information processing apparatus 2 and the output of the forward propagation, and trains the second inference model by backpropagating the difference as loss information in order of the output layer 305, the intermediate layer C 304, the intermediate layer B 303, the intermediate layer A 302, and the input layer 301.

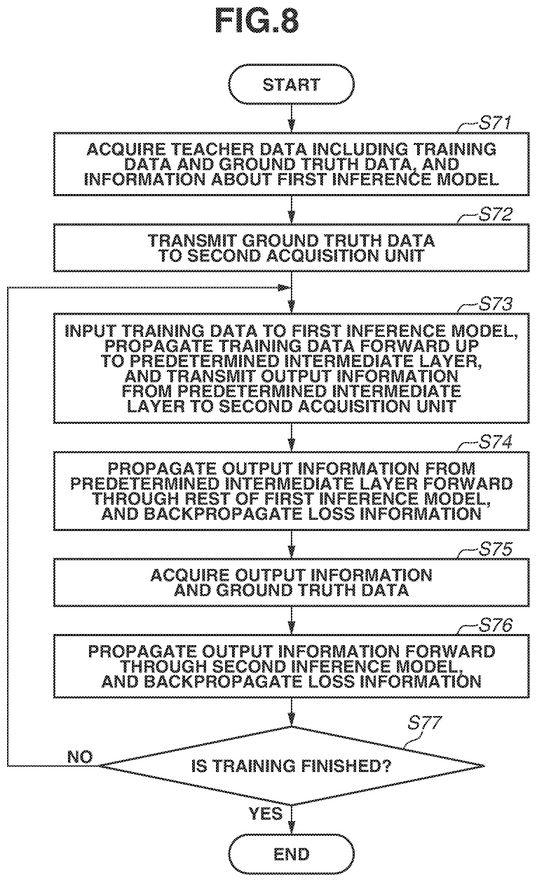

The training procedure of the information processing system 1 according to the present modification will now be described with reference to FIG. 8. Step S71 is the same as step S31, and a description thereof will thus be omitted.

In step S72, the first training unit 7 transmits the ground truth data to the second acquisition unit 10 via the transmission unit 8. The processing then proceeds to step S73.

In step S73, the first training unit 7 inputs the training data to the first inference model, propagates the training data forward up to a predetermined intermediate layer, and duplicates the output information from the predetermined intermediate layer. The first training unit 7 propagates one of the duplicates simply forward through the rest of the first inference model, and transmits the other to the second acquisition unit 10 of the second information processing apparatus 3 via the transmission unit 8 through the network 4. The processing then proceeds to step S74.

In step S74, the first training unit 7 acquires the output information from the predetermined intermediate layer in step S73 and propagates the output information forward through the rest of the first inference model (the intermediate layers subsequent to the predetermined intermediate layer). The first training unit 7 calculates loss information, which is the difference between the output of the forward propagation and the ground truth data, and trains the first inference model by backpropagating the loss information. The processing then proceeds to step S75.

In step S75, the second acquisition unit 10 acquires the output information from the predetermined intermediate layer and the ground truth data from the transmission unit 8, and transmits the acquired pieces of information to the second training unit 11. The processing then proceeds to step S76.

In step S76, the second training unit 11 inputs the acquired output information to the intermediate layers subsequent to a predetermined layer and propagates the output information forward. The second training unit 11 calculates loss information between the resulting output and the acquired ground truth data, and trains the second inference model by backpropagating the loss information.

In step S77, the first training unit 7 determines whether the training of the first inference model is finished. If there is teacher data to be used for training (NO in step S77), the processing returns to step S73. If there is no teacher data (YES in step S77), the processing ends.

With the configuration according to the present modification, it is possible to increase the contribution of the training processing speed of the second information processing apparatus 3 in training the second inference model by transmitting the output of the intermediate layer, in addition to the effect of the foregoing exemplary embodiment.

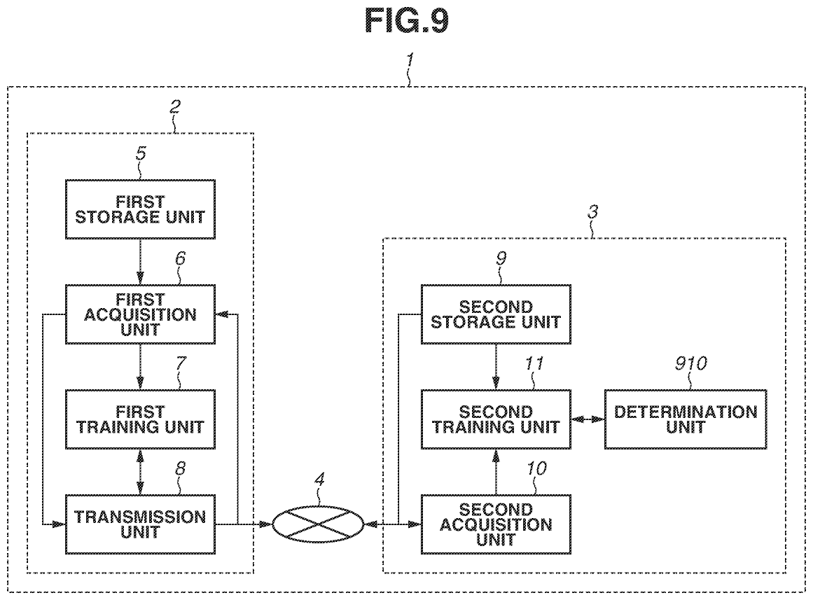

A functional configuration of the information processing system 1 according to a second exemplary embodiment will be described with reference to FIG. 9.

In the present exemplary embodiment, the second information processing apparatus 3 further includes a determination unit 910 that determines whether an inference model is appropriately trained. By monitoring the training of the second inference model, the determination unit 910 can determine whether the first inference model in the first information processing apparatus 2 is trained in an unintended manner, and thus prevent an unintended drop in accuracy. Unintended training refers to training of an inference model using training data tampered so that the inference model provides erroneous output with respect to certain training data, like an adversarial attack. The unintended training is detected by a conventional technique.

More specifically, the determination unit 910 compares the parameters of the inference model distributed to the user with those of the inference model being subjected to training processing by the user, and determines, based on the change in the parameters, whether the training exceeds a predetermined range. If the determination unit 910 determines that the training exceeds the predetermined range, the determination unit 910 does not permit update of the common inference model. Based on the determination, at least either the first training unit 7 or the second training unit 11 prohibits the training processing on the inference model, or uses, as the common inference model, the second inference model before training instead of the second inference model subjected to the training processing. A drop in the accuracy of the inference model is thereby prevented.

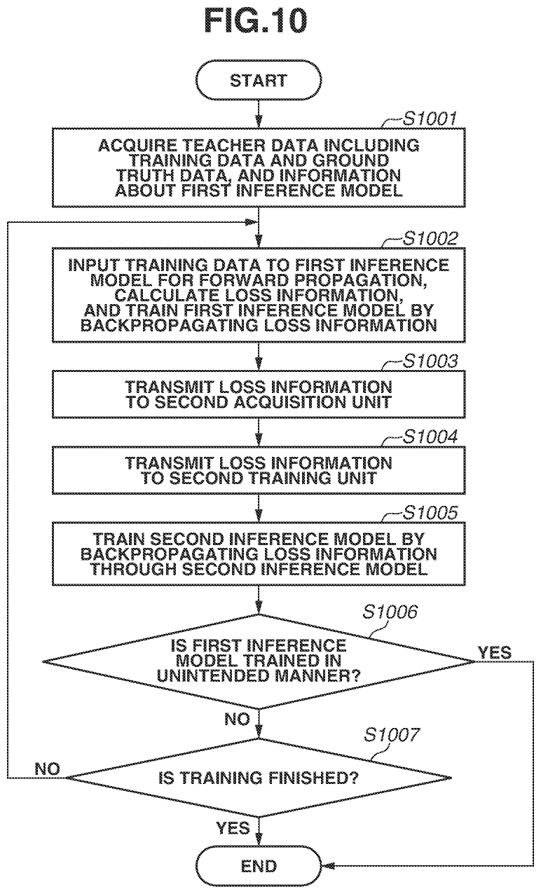

The training processing by the information processing system 1 according to the present exemplary embodiment will be described with reference to FIG. 10.

Steps S1001 to S1005 are the same as steps S31 to S35. A description thereof will thus be omitted.

In step S1006, the determination unit 910 determines whether the first inference model in the first information processing apparatus 2 is trained in an unintended manner, by determining whether the second inference model is appropriately trained. If the determination unit 910 determines that the first inference model is not trained in an unintended manner (NO in step S1006), the processing proceeds to step S1007. If the determination unit 910 determines that the first inference model is trained in an unintended manner (YES in step S1006), the processing ends.

In step S1007, the first training unit 7 determines whether the training of the first inference model is finished. If the training is not finished (NO in step S1007), the processing returns to step S1002. If the training is finished (YES in step S1007), the processing ends.

In the foregoing exemplary embodiment, the case has been described where the second information processing apparatus 3 detects the unintended training of the first inference model in the first information processing apparatus 2 by monitoring the training of the second inference model. The present exemplary embodiment is not limited thereto. If the first inference model in the first information processing apparatus 2 is detected as being trained in an unintended manner, the update of the training of the second inference model in the second information processing apparatus 3 may be stopped and an alert may be issued to stop updating the training of the first inference model in the first information processing apparatus 2.

This enables the inference model user to recognize that unintended training is underway in the first information processing apparatus 2, and take action such as using the inference model before the unintended training or not using the inference model.

A third exemplary embodiment deals with a case where a common inference model is trained in a plurality of hospitals (by a plurality of inference model users), and an inference model on a server, which is an information processing apparatus of an inference model provider, is updated using loss information, which is output information based on forward propagation, calculated by information processing apparatuses of the inference model users.

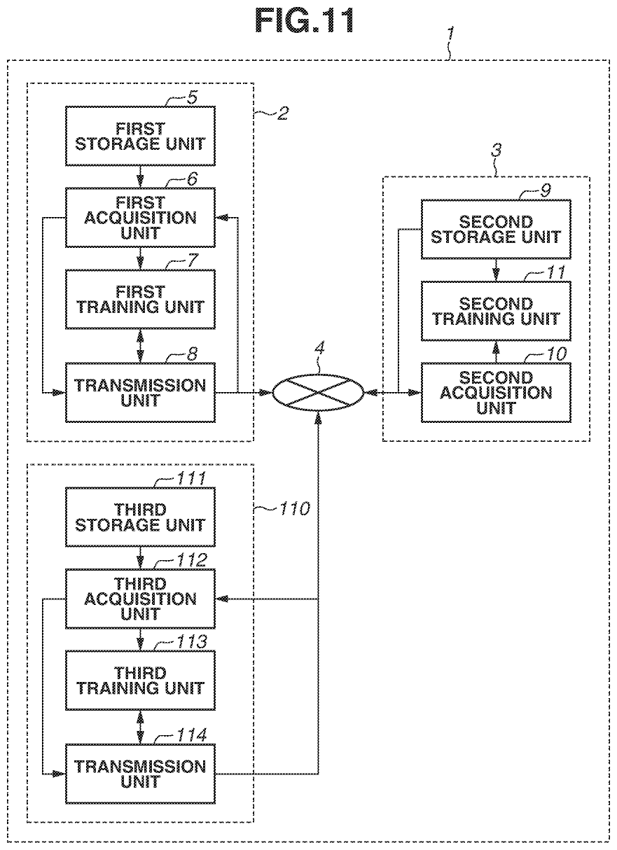

The information processing system 1 according to the present exemplary embodiment will now be described with reference to FIG. 11.

The information processing system 1 according to the present exemplary embodiment includes the first information processing apparatus 2, the second information processing apparatus 3, and a third information processing apparatus 110. The first information processing apparatus 2 and the third information processing apparatus 110 are information processing apparatuses of inference model users, i.e., inference model distribution destinations. The second information processing apparatus 3 is an information processing apparatus of an inference model provider, i.e., an inference model distribution source, and can communicate with the first information processing apparatus 2 and the third information processing apparatus 110 via the network 4. The first information processing apparatus 2 and the third information processing apparatus 110 each include, as a common inference model with the second information processing apparatus 3, a trained inference model subjected to training processing by the model provider in advance or an untrained inference model. Similarly to the first information processing apparatus 2, the third information processing apparatus 110 includes a third storage unit 111, a third acquisition unit 112, a third training unit 113, and a transmission unit 114.

In the present exemplary embodiment, the information processing system 1 inputs training data to the first inference model in the first information processing apparatus 2, and trains the first inference model at the first information processing apparatus 2. The first information processing apparatus 2 transmits loss information calculated based on output resulting from forward propagation of the training data and ground truth data to the second information processing apparatus 3 and the third information processing apparatus 110.

The second information processing apparatus 3 and the third information processing apparatus 110 each train the second inference model, which is a common inference model with the first information processing apparatus 2, by backpropagation using the loss information.

The present exemplary embodiment has dealt with the case where two information processing apparatuses as inference model distribution destinations, namely, the first information processing apparatus 2 and the third information processing apparatus 110 are provided. However, this is not restrictive, and the number of information processing apparatuses as inference model distribution destinations may be three or more.

In the present exemplary embodiment, the information processing system 1 having such a configuration can train the second inference model in the information processing apparatus of the model provider without transmitting the teacher data to the second information processing apparatus 3. Moreover, the loss information and the parameters based on the loss information can be updated in a timely manner as compared to a case where the model provider performs all the training processing and then acquires the updated parameters. The model provider can thus check the progress of parameter updates.

In the foregoing exemplary embodiment, the case has been described where the inference model provided from the second information processing apparatus 3 to the first information processing apparatus 2 is an untrained inference model. The present exemplary embodiment is not limited thereto, and an inference model trained in advance by the second information processing apparatus 3 may be provided as the inference model to the user. The inference model to be provided can thus be trained in advance with various images.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-128578, filed Aug. 12, 2022, which is hereby incorporated by reference herein in its entirety.

What is claimed is:

1. An information processing system comprising:
a first information processing apparatus; and
a second information processing apparatus communicable with the first information processing apparatus via a network,
wherein the first information processing apparatus includes:
a first inference model acquisition unit configured to acquire a first inference model based on a first neural network including a first input layer, a first intermediate layer group, and a first output layer,
a first training unit configured to train the first inference model using teacher data, and
a transmission unit configured to transmit output information based on forward propagation by the first training unit to the second information processing apparatus, and
wherein the second information processing apparatus includes:
a second inference model acquisition unit configured to acquire a second inference model based on a second neural network including a second input layer, a second intermediate layer group, and a second output layer, wherein the second inference model is a common inference model and is similar to the first inference model, and
a second training unit configured to train the second inference model based on the output information.

2. The information processing system according to claim 1, wherein the output information is output information from the first intermediate layer group of the first neural network in the forward propagation of training data, wherein the training data is included in the teacher data.

3. The information processing system according to claim 1, wherein the output information is loss information between output in the forward propagation of training data and ground truth data, wherein the training data and the ground truth data are included in the teacher data.

4. The information processing system according to claim 2, further comprising an update unit configured to update the common inference model using the second inference model trained by the second training unit.

5. The information processing system according to claim 4, further comprising a second transmission unit configured to transmit the second inference model to another information processing apparatus.

6. The information processing system according to claim 2,
wherein the first information processing apparatus is managed by an entity to which the first inference model is distributed, and
wherein the second information processing apparatus is managed by an inference model creator.

7. The information processing system according to claim 2,
wherein the information processing system includes a plurality of the first information processing apparatuses of different entities, and
wherein the first training unit performs training processing.

8. The information processing system according to claim 2, further comprising a determination unit configured to determine whether training processing by the second training unit is training exceeding a predetermined range as compared to the common inference model.

9. The information processing system according to claim 8, wherein, in a case where the determination unit determines that the training processing is the training exceeding the predetermined range, the common inference model is not updated.

10. The information processing system according to claim 1, wherein the first inference model is an inference model distributed from the second information processing apparatus.

11. The information processing system according to claim 10, wherein the second information processing apparatus pre-trains the second inference model and distributes the pre-trained second inference model as the common inference model.

12. A method for training an inference model, the method comprising:
acquiring loss information that is a difference between ground truth data and output of a common inference model, wherein the loss information is acquired from another information processing apparatus; and
training the common inference model based on the loss information.

13. A non-transitory computer-readable storage medium storing instructions that, when executed by a computer, configure the computer to perform a method comprising:
acquiring loss information that is a difference between ground truth data and output of a common inference model, wherein the loss information is acquired from another information processing apparatus; and
training the common inference model based on the loss information.

14. An information processing apparatus comprising:
a first inference model acquisition unit configured to acquire a first inference model based on a first neural network including a first input layer, a first intermediate layer group, and a first output layer;
a first training unit configured to train the first inference model using teacher data; and
a transmission unit configured to transmit output information based on forward propagation by the first training unit to a second information processing apparatus that is another information processing apparatus.

15. An information processing apparatus comprising:
an acquisition unit configured to acquire output information from a first inference model that is calculated by another information processing apparatus;
a second inference model acquisition unit configured to acquire a second inference model based on a second neural network including a second input layer, a second intermediate layer group, and a second output layer, wherein the second inference model is a common inference model and is similar to the first inference model; and
a second training unit configured to train the second inference model based on the output information.
